(19) United States
(12) Patent Application Publication
(10) Pub. No.: US 2009/0135773 A1
(43) Pub. Date: May 28, 2009

(54) MEASUREMENT REPORTING FOR TRANSMISSIONS SUPPORTING LATENCY REDUCTION

(75) Inventors: Behrouz Aghili, Melville, NY (US); Marian Rudolf, Montreal (CA); Stephen G. Dick, Nesconset, NY (US); Yan Li, Center Valley, PA (US); Prabhakar R. Chitrapu, Blue Bell, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/270,551

(22) Filed: Nov. 13, 2008

Related U.S. Application Data
(60) Provisional application No. 60/987,599, filed on Nov. 13, 2007.
(60) Provisional application No. 61/012,217, filed on Dec. 7, 2007.
(60) Provisional application No. 61/027,179, filed on Feb. 8, 2008.
(60) Provisional application No. 61/029,784, filed on Feb. 19, 2008.

(51) Int. Cl. H04W 72/04

(52) U.S. Cl. 370/329

(57) ABSTRACT

A method for accounting for the presence of a piggybacked acknowledgement/negative acknowledgement (PAN) field in reporting a received signal quality for a current wireless transmit/receive unit (WTRU) is disclosed. A determination is made whether a received radio block is intended for the current WTRU. The received signal quality of the radio block is measured if the radio block is intended for the current WTRU. Bits from the PAN field are included in determining the received signal quality of the radio block based on a preconfigured option. The radio block measurement is included in a measurement report if a data header of the radio block is not addressed to the current WTRU but the PAN field is addressed to the current WTRU.

### CROSS REFERENCE TO RELATED APPLICATIONS

This application claims the benefit of U.S. Provisional Application No. 60/987,599 filed on Nov. 13, 2007; U.S. Provisional Application No. 61/012,217 filed on Dec. 7, 2007; U.S. Provisional Application No. 61/027,179 filed on Feb. 8, 2008; and U.S. Provisional Application No. 61/029,784 filed on Feb. 19, 2008, which are incorporated by reference as if fully set forth herein.

### FIELD OF INVENTION

This application is related to wireless communications.

### BACKGROUND

A goal for GSM EDGE Radio Access Network (GERAN) evolution is to develop new technology, new architecture, and new methods for settings and configurations in wireless communication systems. Release 7 (R7) of the 3GPP GERAN standard introduces several features to improve throughput and reduce latency of transmissions in the uplink (UL) and the downlink (DL).

For example, the EGPRS-2 feature consists of UL and DL improvements. UL improvements are referred to as higher uplink performance for GERAN evolution (HUGE), and DL improvements are referred to as reduced symbol duration higher order modulation and turbo coding (REDHOT). Both of these improvements may generally be referred to as enhanced general packet radio service 2 (EGPRS-2) features.

REDHOT and HUGE provide increased data rates and throughput compared to legacy EGPRS DL and UL. These modes may be implemented through the use of higher order modulation schemes, such as 16-quadrature amplitude modulation (16-QAM) and 32-QAM. These modes may also involve the use of higher symbol rate transmissions and turbo-coding. Similar to legacy systems, REDHOT and HUGE involve an extended set of modulation and coding schemes that define new modified information formats in the bursts, various coding rates and coding techniques and the like.

Another feature that is part of the GERAN R7 improvements is latency reduction (LATRED), which is designed to reduce transmission delays, to increase data throughput, and to provide a better quality of service. The latency reduction feature consists of two technical approaches that may operate either in a stand-alone mode, in conjunction with each other, or in conjunction with any of the other GERAN R7 improvements. A first approach incorporated into the LATRED feature is the fast acknowledgement/negative acknowledgement (ACK/NACK) reporting (FANR) mode. A second approach incorporated into the LATRED feature is the reduced transmission time interval (RTTI) mode. A wireless transmit/receive unit (WTRU) may operate in both FANR and RTTI modes of operation with legacy EGPRS modulation and coding schemes (MCSs), and with the newer EGPRS-2 modulation and coding schemes. In addition, the LATRED feature consisting of both the FANR and RTTI modes can operate in conjunction with other GSM R7 and beyond improvements, such as the Downlink Dual-Carrier (DLDC) mode of operation, for example.

Prior to the introduction of FANR, ACK/NACK information was typically sent in an explicit message, referred to as a radio link control (RLC)/medium access control (MAC) protocol message (also referred to as a RLC/MAC control block), which contained a starting sequence number and a bitmap representing radio blocks. Examples for such explicit RLC/MAC protocol messages include packet downlink ACK/NACK or packet uplink ACK/NACK messages.

The RLC/MAC control block is addressed to a certain radio resource, called a temporary block flow (TBF). A TBF is a temporal connection between a WTRU and a network to support a unidirectional data transfer and is maintained only for the duration of the data transfer. If supported by the WTRU and the network, more than one TBF can be allocated to a WTRU. Each TBF is assigned a temporary flow identity (TFI) by the network. The TFI is unique among concurrent TBFs in each direction and is used instead of the WTRU identity in the RLC/MAC layer. For example, in GPRS and EGPRS modes of operation, the same TFI is included in every RLC/MAC header belonging to a particular TBF to allow the intended receiver (i.e., the WTRU or network) to determine the addressee of a received radio block.

To reduce transmission latencies associated with using an entire RLC/MAC control block, another mode of ACK/NACK operation in GSM/(E)GPRS R7 has been incorporated and is referred to as the FANR mode of operation. The ACK/NACK report for a certain TBF is “piggybacked” onto an RLC/MAC data block by puncturing a number of bits from the channel-coded data portion of the radio block with no data loss. This new field (called the piggybacked ACK/NACK (PAN) field) is inserted, when needed, into the RLC/MAC data block and carries the ACK/NACK report as part of the radio block. The PAN can be inserted in both the DL and UL directions and each direction can be configured separately. When the PAN field is sent to a WTRU in the DL, it carries ACKs or NACKs for data units or protocol data units (PDUs) previously sent by the WTRU in the UL direction, and vice versa.

The presence or absence of the PAN field in a radio block is indicated by the RLC/MAC header, either by a bit or bit field setting or by setting other code points depending on the RLC/MAC header type. The latter indication depends on the EGPRS/EGPRS-2 modulation and coding scheme chosen to transmit the radio block. In the DL direction, the PAN field of an RLC/MAC data block may be addressed to a WTRU that is not the intended receiver of the data units (or PDUs) in the radio block. Alternatively, the PAN field and the data units (or PDUs) of the radio block may be intended for the same WTRU. Both for the DL and UL directions, the TBF to which the PAN field refers may be different from the TBF corresponding to the data units (or PDUs) of the radio block, even if the receiver is the same physical unit (WTRU or network).

The actual bit field(s) carrying the ACKs or NACKs in the PAN field may be encoded according to one of two different procedures: a starting sequence number (SSN)-based approach or a time-based approach. For both SSN-based and time-based FANR operation, the PAN field is in principle the same, but the encoding approach differs.

When the SSN-based ACK/NACK mode is used, the PAN field includes an SSN and a reported bitmap, which relates to a series of RLC/MAC data blocks starting from the SSN. The PAN field contains parameters that identify what block sequence number (BSN) the bitmap corresponds to. A BSN is included in every RLC data block.

For the time-based FANR, the PAN field bits comprise a bitmap, where pairs of bits refer to the decoding status of one or two RLC data block(s) on a given packet data channel (PDCH) in a given preceding transmission time interval (TTI). The time-based ACK/NACK mode is particularly suitable to real time services such as voice over Internet Protocol (VoIP). When the time-based ACK/NACK mode is used, instead of referencing the ACK/NACK report to SSNs, the ACK/NACK report refers to previously received RLC/MAC data blocks and the RLC/MAC data PDU(s) contained therein, sent by one or more WTRU(s) in the UL as given by a known or induced timing relationship.

The time-based PAN field includes a bitmap providing feedback information relative to the reception of previously received UL RLC/MAC blocks at the network side. As a function of the PAN field's bitmap size, a certain number of previously received RLC/MAC blocks can be acknowledged. When received in the DL, a time-based PAN field carries information pertaining to more than one WTRU. Because any WTRU can keep track of when it sent RLC/MAC blocks in the UL, it can unambiguously associate the ACK/NACK status in the PAN bitmap with its own transmissions (and ignore those of other WTRUs), because the timing relationship is known and fixed.

The SSN-based FANR method is used to convey ACK/NACKs for the DL TBFs. However, for the UL TBFs, either the SSN-based or the time-based FANR method may be used. The base station subsystem (BSS) configures the FANR ACK/NACK mode to acknowledge the UL transmissions when FANR is activated. When the time-based FANR mode is configured, all UL TBFs in use by the WTRU must operate in the time-based ACK/NACK mode.

Prior to GSM R7, the reporting strategy (how and when ACK/NACK reports are sent, and the like) was controlled by the network. The WTRU would send an RLC/MAC control block in response to a poll from the base station system (BSS). The poll includes information about the UL transmission time (for example, when the WTRU is allowed to send its control block in the UL). During normal operation, when higher layer information is exchanged between the WTRU and the network, the information transfer occurs using RLC data blocks.

Prior to GSM R7, legacy EGPRS permitted transmission only in a basic transmission time interval (BTTI) format. BTTI transmission requires the transmission of four bursts per radio block. Each burst is sent on the same assigned timeslot per frame over four consecutive frames. For example, if a WTRU is assigned timeslot (TS) 3, it may receive an entire radio block by extracting a first burst from TS 3 in frame (N), a second burst from TS 3 in frame (N+1), third burst from TS 3 in frame (N+2), and a fourth burst from TS 3 in frame (N+3), where N is an integer value. As each frame has duration of 4.615 ms, the transmission of an entire radio block takes four frames×4.615 ms, or approximately 20 ms. It is also possible that a WTRU is assigned more than one TS for data reception by using multislot transmission and/or reception capabilities. Therefore, any of the assigned timeslots may contain a separate radio block received over a duration of 20 ms. The exact time that a radio block can start (i.e., the location of the GSM frame that contains the first burst) is given by frame timing rules in the GSM standard.

GSM R7 also may include using a reduced transmission time interval (RTTI) format, where a pair of timeslots in a first frame contains a first set of two bursts, and second frame contains a second set of two bursts. The first and second frames of the four total bursts make up the radio block. A transmission using RTTI therefore only takes two frames×4.615 ms, or roughly 10 ms. RTTI operation is possible with both EGPRS and EGPRS-2 radio blocks.

Multiple WTRUs may share the same UL and/or DL resources. This may be accomplished by multiplexing the DL signals for the multiple WTRUs on the single physical resource, such as the Packet Data Channel (PDCH), for example.

A WTRU, such as a legacy WTRU, for example, can operate in BTTI mode only. The GSM R7 standard includes a number of possibilities to assign WTRUs to timeslots in conjunction with BTTI and/or RTTI operation. In a first mode of operation, one or more timeslots are exclusively assigned to WTRUs with TBFs operating in BTTI mode only. In a second mode of operation, one or more pairs of timeslots are exclusively assigned to WTRUs with TBFs operating in RTTI mode only. In a third mode of operation, one or more timeslots are assigned to WTRUs with one or more TBFs operating in BTTI mode simultaneously with one or more TBFs on the same timeslots operating in RTTI mode.

Constraints arise when WTRUs that are not RTTI compatible are multiplexed with WTRUs that are using RTTI. For example, transmissions to WTRUs that are assigned one or more TBFs using the RTTI format may be multiplexed onto shared timeslots with a BTTI WTRU. The RTTI WTRUs must respect the legacy uplink state flag (USF) format and corresponding stealing flag (SF) settings of legacy BTTI WTRUs.

Also, legacy burst processing techniques may create a problem. A legacy BTTI WTRU may determine the modulation type of a received radio block by processing the radio block with appropriate phase rotations and burst detection techniques before attempting to process the SF, the USF, and the RLC/MAC header information. Therefore, two consecutive RTTI radio blocks that may be sent to a legacy WTRU during one legacy BTTI time interval should include the same modulation type in each radio block, so as to not impact USF decoding ability by the legacy BTTI WTRU. For example, both radio blocks may be GMSK, or both radio blocks may be 8PSK, but they should not be mixed.

A BTTI WTRU may assume that any BTTI radio block on its assigned timeslots and transmitted over a period of four consecutive GSM frames can only start at certain, well-defined instances, for example, in frame (N), (N+4), or (N+8), where N is an integer value. Therefore, if an RTTI block is transmitted to an RTTI WTRU in frames N and (N+1), for example, a BTTI radio block to a second WTRU can not be transmitted starting in frame (N+2). It has been a working assumption that if a first RTTI block is transmitted in the first 10 ms of a 20 ms time BTTI interval, then a second RTTI block will follow. This occurs when the BTTI/RTTI signals are multiplexed or non-multiplexed because legacy WTRUs assume that transmission of radio blocks is on a 20 ms TTI basis.

In GSM R7 using EGPRS, the PAN field can be inserted into radio blocks together with the currently defined MCSs (except for MCS-4 and MCS-9, where the FANR mode of operation is not possible) for EGPRS. Also, the PAN field can be inserted with the new MCSs provided by the EGPRS-2 feature, i.e., the new set of MCSs introduced by REDHOT/HUGE. In both modes of operation, FANR in conjunction with an EGPRS MCS or FANR in conjunction with an EGRPS-2 MCS, the radio block is encoded in three different portions, including:

(1) a separately encoded RLC/MAC header (decodable independent from the RLC data payload);

(2) an RLC data payload; and

(3) an optional PAN field, separately decodable from the RLC/MAC header and the RLC data payload.

The different portions of a radio block are shown in FIG. 1, including legacy MCSs and some of the new MCSs for REDHOT and HUGE. While not shown in FIG. 1, the payload may contain up to two RLC data blocks when using EGPRS MCSs, or up to three or four RLC data blocks when using EGPRS-2 MCSs. It is noted that using the LATRED feature in conjunction with features such as DLDC uses, by definition, either an EGPRS or an EGPRS-2 MCS. All considerations given here extend to this and similar features where the LATRED feature is employed in conjunction with other features.

Measurements Taken

In GSM, GPRS, and EGPRS, measurements are taken at the WTRU and reported to the base station. Two of the more important measurements include signal strength and signal quality. Signal strength is what the WTRU uses to reselect to a neighboring cell when the current cell becomes too weak. Signal quality relates to an ongoing packet data communication. One measurement of channel quality is the bit error probability (BEP), which is averaged over a defined time interval referred to as the BEP Period. BEP is measured on a burst received from the network and is based on the modulation of symbols in the packet domain. BEP is a reflection of the current signal to interference ratio, the time dispersion of the signal, and the velocity of the WTRU. The variation of the BEP over several bursts can provide an indication of the velocity of the WTRU and the amount of frequency hopping that is occurring.

MEAN BEP and CV BEP

For EGPRS, the WTRU first calculates the BEP for each radio burst (BEP_{burst}) by a proprietary algorithm. The mean bit error probability (MEAN_BEP) of a radio block, which consists of four radio bursts, is then calculated, according to the equation:

$${MEAN\_BEP}_{block} = \frac{1}{4} {\sum }_{i = 1}^{4} {BEP}_{burst i} \qquad Equation ( 1 )$$

Then the coefficient of variation (CV) of the BEP (CV_BEP) of a radio block (the standard deviation of the BEP divided by the MEAN_BEP) is calculated as follows:

$${CV\_BEP}_{block} = \frac{\sqrt{\frac{1}{3} {\sum }_{i = 1}^{4} {( {BEP}_{burst k} - \frac{1}{4} {\sum }_{i = 1}^{4} {BEP}_{burst i} )}^{2}}}{\frac{1}{4} {\sum }_{k = 1}^{4} {BEP}_{burst i}} \qquad Equation ( 2 )$$

The MEAN_BEP and CV_BEP, which are calculated for successive radio blocks, are filtered by a first order linear recursive filter. The filtering is specific to a particular timeslot and for a particular modulation (e.g., Gaussian minimum shift keying (GMSK) or 8PSK). The filtering is performed using the following equations:

$$\begin{matrix}{R}_{n} = ( 1 - e ) \cdot {R}_{n - 1} + e \cdot {x}_{n} , {R}_{- 1} = 0 & Equation ( 3 ) \\ MEAN\_BEP {\_TN}_{n} = ( 1 - e \cdot \frac{{x}_{n}}{{R}_{n}} ) \cdot MEAN\_BEP {\_TN}_{n - 1} + e \cdot \frac{{x}_{n}}{{R}_{n}} \cdot {MEAN\_BEP}_{block , n} & Equation ( 4 ) \\ CV\_BEP {\_TN}_{n} = ( 1 - e \cdot \frac{{x}_{n}}{{R}_{n}} ) \cdot CV\_BEP {\_TN}_{n - 1} + e \cdot \frac{{x}_{n}}{{R}_{n }} \cdot {CV\_BEP}_{block , n} & Equation ( 5 )\end{matrix}$$

where n is the iteration index, incremented per each downlink radio block. The variable Rₙ denotes the reliability of the filtered quality parameters for the respective modulation type. The variable e is the forgetting factor, defined below, and is a function of the parameter BEP_PERIOD or BEP_PERIOD2. The network may signal the BEP_PERIOD2 value to the WTRU. If received, the WTRU uses the BEP_PERIOD2 value and the corresponding forgetting factor e₂. The variable xₙ denotes the existence of quality parameters for the n^{th} block for the respective modulation type, i.e., if the radio block is intended for this WTRU. The values 1 and 0 for the variable xₙ denote the existence and absence of quality parameters, respectively.

Using the averaging rules, Rₙ is a measure of the probability that a block of data is correctly decoded provided that the block is intended for this WTRU. Therefore, n is only incremented when a block is addressed to this WTRU. If all data blocks are successfully decoded, then R converges to 1.0. This operation is not affected by using the RTTI mode.

The BEP_PERIOD is broadcast on the packet broadcast control channel (PBCCH) or, if the PBCCH does not exist, on the broadcast control channel (BCCH) and is common to all WTRUs in a cell. The BEP_PERIOD2 is specific to a WTRU and is transmitted to the individual WTRU on the packet associated control channel (PACCH) DL. The values of BEP_PERIOD and BEP_PERIOD2 and the corresponding forgetting factors needed for the filtering are given in Table 1. BEP_PERIOD and BEP_PERIOD2 are expressed as a number of radio blocks addressed to the WTRU. It is optional for the network to signal BEP_PERIOD2 to the WTRU. If sent, BEP_PERIOD2 is broadcast in dedicated signaling messages, whereas BEP_PERIOD is broadcast on the System Information messages. If BEP_PERIOD2 has been signaled to the WTRU, then it overrides BEP_PERIOD. If the value 15 is sent for BEP_PERIOD2, then the values of e₁ and e₂ are equal and the parameter “e” is the same as e₁.

TABLE 1

| | Field value | | | | | | | | | | | | | | | |
|---|---|---|---|---|---|---|---|---|---|---|---|---|---|---|---|---|
| | 15 | 14 | 13 | 12 | 11 | 10 | 9 | 8 | 7 | 6 | 5 | 4 | 3 | 2 | 1 | 0 |
| BEP_PERIOD | Reserved | | | | | 25 | 20 | 15 | 12 | 10 | 7 | 5 | 4 | 3 | 2 | 1 |
| e₁ | — | | | | | 0.08 | 0.1 | 0.15 | 0.2 | 0.25 | 0.3 | 0.4 | 0.5 | 0.65 | 0.8 | 1 |
| BEP_PERIOD2 | Norm | 90 | 70 | 55 | 40 | 25 | 20 | 15 | 12 | 10 | 7 | 5 | 4 | 3 | 2 | 1 |
| e₂ | e₁ | 0.03 | 0.04 | 0.05 | 0.065 | 0.08 | 0.1 | 0.15 | 0.2 | 0.25 | 0.3 | 0.4 | 0.5 | 0.65 | 0.8 | 1 |

Finally, the timeslot specific filtered BEP and CV are then averaged over all allocated channels (timeslots) as follows:

$$\begin{matrix}{MEAN\_BEP}_{n} = \frac{{\sum }_{j} {R}_{n}^{( j )} \cdot MEAN\_BEP {\_TN}_{n}^{( j )}}{{\sum }_{j} {R}_{n}^{( j )}} & Equation ( 6 ) \\ {CV\_BEP}_{n} = \frac{{\sum }_{j} {R}_{n}^{( j )} \cdot CV\_BEP {\_TN}_{n}^{( j )}}{{\sum }_{j} {R}_{n}^{( j )}} & Equation ( 7 )\end{matrix}$$

where n is the iteration index at the reporting time, and j is the channel (timeslot) number.

When entering packet transfer mode or a MAC-shared state and/or when selecting a new cell, the filters reset the values of n to 0. When a new timeslot is allocated for a DL TBF, the filters reset the values of MEAN_BEP_TNₙ₋₁, CV_BEP_TNₙ₋₁, and Rₙ₋₁ to 0 for the current timeslot.

Reporting

The WTRU transfers γ_{CH} (a channel-specific power control parameter), RX_QUAL (received signal quality), C (a received signal level at the WTRU), and SIGN_VAR (a filtered value of the variance of the received signal level) values to the network in the Channel Quality Report transmitted on the PACCH. However, a WTRU using EGPRS transmits the MEAN_BEP and CV_BEP values instead of the RX_QUAL and SIGN_VAR values.

The WTRU reports the overall MEAN_BEP and CV_BEP for the modulations for which it has received blocks over at least one allocated channel (timeslot) since it last transmitted a measurement report to the network. For example, for GMSK and/or 8-PSK, the WTRU reports GMSK_MEAN_BEP and GMSK_CV_BEP and/or 8PSK_MEAN_BEP and 8PSK_CV_BEP respectively. Additionally, the WTRU reports per slot measurements (MEAN_BEP_TNx) according to what the network has ordered.

The GERAN specification also instructs the WTRU on the conditions for measuring the received signal quality. During an EGPRS downlink TBF transfer, the WTRU measures the received signal quality. The quality parameters are measured for the radio blocks intended for this WTRU only, i.e., at least the radio blocks where the TFI identifying the current WTRU can be decoded from the RLC/MAC header and radio blocks where the TFI identifying the current WTRU can be decoded from the RLC/MAC control block header.

There are currently no rules established to properly account for the presence of a PAN field in a transmission when radio blocks are demodulated or received employing the LATRED feature. The reason is that legacy GSM measurement procedures only distinguish between radio blocks containing a transmission for a WTRU, versus radio blocks that do not contain a transmission for the WTRU. If the WTRU determines that a radio block does not contain a transmission for it, this radio block is not taken into account during the measurement process (although the time elapsed is accounted for when computing a measurement upon receipt of the next radio block containing a transmission for that WTRU). With the introduction of the LATRED feature, there can be radio blocks that contain a PAN field for the WTRU in question, even though the transmission itself (i.e., the data portion) is directed towards another WTRU. Furthermore, because the radio block encoding in legacy GSM radio blocks just distinguishes between an RLC/MAC header and a data portion, current GSM measurements are not defined in terms of how to deal with and how to represent the measurement quality on the PAN field portion of any radio block.

Additionally, the current averaging procedures are not appropriate for the scenario where a set of transmissions to (or from) a specified WTRU are transmitted using the RTTI format when employing the LATRED feature. Because RTTI transmissions result in up to twice as many radio blocks per unit time compared to a legacy BTTI transmission, the number of BEP measurements is increased by an un-deterministic factor as compared to a legacy BEP_PERIOD with the BTTI transmission format.

Accordingly, a method and apparatus for improved measurement updating for transmissions supporting latency reduction is desired, both for the cases of FANR and RTTI, and in conjunction with any of the EGPRS or EGPRS-2 MCSs. The principles disclosed herein are also applicable in conjunction with any GSM R7 or beyond feature that can be operated together with the LATRED feature, such as the Downlink Dual-Carrier (DLDC) mode, for example.

In a summary, a first problem is that some of the current measurement and measurement averaging and reporting formulas used are based on measurements that do not take into account the particular characteristics of an RTTI transmission. A second problem is that the presence of the PAN field is not accounted for, specifically, if a data block is not addressed to a WTRU, the PAN field in the block could still be addressed to the WTRU and any measurement procedure and measurement process needs to handle the resulting cases accordingly. Furthermore, not every DL radio block includes a PAN field, which also must be accounted for in revising the measurement procedures. The current GSM R7 measurement procedures do not consider this scenario resulting from the introduction of the LATRED feature.

### SUMMARY

A method and apparatus for measurement reporting by a WTRU in the presence of transmissions supporting the FANR mode of the latency reduction feature are disclosed. The method and apparatus include receiving a signal at a WTRU, measuring one or more metrics representative of either all or a subset of the received signals, and performing measurements on radio blocks which include the PAN field. Also disclosed are a method and apparatus for taking and reporting measurements by a WTRU in the presence of transmissions supporting the RTTI mode of the latency reduction feature. The method and apparatus include receiving a signal at a WTRU, measuring one or more metrics representative of either all or a subset of the received signals, and performing measurements on radio blocks which are sent using the RTTI mode of the latency reduction feature.

### BRIEF DESCRIPTION OF THE DRAWINGS

A more detailed understanding may be had from the following description, given by way of example in conjunction with the accompanying drawings, wherein:

FIG. 1 shows different portions of a radio block;

FIG. 2 is a block diagram of a WTRU and a base station;

FIG. 3 is a flowchart of a method for supporting the PAN field during measurements; and

FIG. 4 shows radio block transmissions in BTTI and RTTI modes.

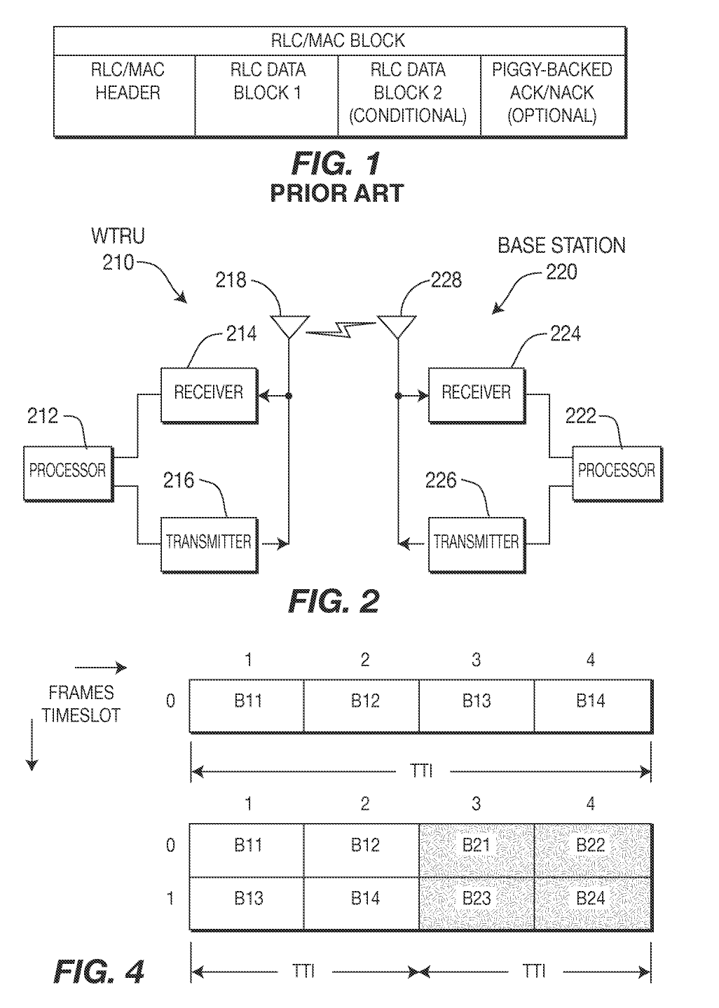

### DETAILED DESCRIPTION

When referred to hereafter, the term “wireless transmit/receive unit (WTRU)” includes, but is not limited to, a user equipment (UE), a mobile station, a fixed or mobile subscriber unit, a pager, a cellular telephone, a personal digital assistant (PDA), a computer, or any other type of user device capable of operating in a wireless environment. When referred to hereafter, the term “base station” includes, but is not limited to, a Node B, a site controller, an access point (AP), or any other type of interfacing device capable of operating in a wireless environment.

FIG. 2 is a block diagram of a WTRU 210 and a base station 220. As shown in FIG. 2, the WTRU 210 is in communication with the base station 220 and both are configured to perform a method of measurement reporting for transmissions supporting latency reduction.

In addition to the components that may be found in a typical WTRU, the WTRU 210 includes a processor 212, a receiver 214, a transmitter 216, and an antenna 218. The processor 212 is configured to perform a method of measurement reporting for transmissions supporting latency reduction. The receiver 214 and the transmitter 216 are in communication with the processor 212. The antenna 218 is in communication with both the receiver 214 and the transmitter 216 to facilitate the transmission and reception of wireless data.

In addition to the components that may be found in a typical base station, the base station 220 includes a processor 222, a receiver 224, a transmitter 226, and an antenna 228. The processor 222 is configured to perform a method of measurement reporting for transmissions supporting latency reduction. The receiver 224 and the transmitter 226 are in communication with the processor 222. The antenna 228 is in communication with both the receiver 224 and the transmitter 226 to facilitate the transmission and reception of wireless data.

Modifications to Support the PAN Field

The following procedures address computing the quality of the radio block including a PAN field. There are two different aspects related to supporting the PAN field in the measurement process and the measurement procedure. The first aspect is whether a WTRU must take into account all radio blocks containing a PAN field for its measurements. The second aspect is whether for those radio blocks that are taken into account, how should the actual resulting measurement then be combined and/or reported.

In a first method, the measurement procedure in the WTRU is modified as follows using any of the described embodiments.

When a WTRU receives a radio block, it determines whether the RLC/MAC header indicates that the radio block contains a data portion addressed to this WTRU. For example, the WTRU can determine this as a function of the TFI contained in the RLC/MAC header. The WTRU also determines whether the RLC/MAC header indicates that this radio block contains a PAN field. For example, the WTRU can determine this as a function of a code point setting or PANI indication in the RLC/MAC header. It is noted that the WTRU can determine to which WTRU an eventually included PAN transmission is addressed only when processing the PAN field itself, because the TFI for the addressed WTRU is implicitly coded into the PAN CRC. Furthermore, if the WTRU determines that the radio block contains a PAN field, it proceeds to decode the PAN field and determines if the PAN field is addressed to it or to some other WTRU.

As a result of the above steps, and not accounting for the presence of decoding errors or the absence of a PAN field in the received radio block, the WTRU will have available the following information: (1) if the radio block contains a data portion addressed to the WTRU (as opposed to some other WTRU) and (2) if the radio block contains a data portion addressed to the WTRU (as opposed to some other WTRU). Not accounting for the decoding error cases, four different possibilities will result:

(1) The WTRU is not addressed in either the data portion or the PAN field (condition A).

(2) The WTRU is addressed in the data portion, but the PAN field is intended for some other WTRU (condition B).

(3) The WTRU is not addressed in the data portion, but the PAN field is intended for it (condition C).

(4) Both the data portion and the PAN field are addressed to the WTRU (condition D).

Subsequently, the WTRU measurement process is modified to account for these conditions to decide if (and how) a received radio block is to be used for the purpose of measurements.

In a first embodiment of the first method, the WTRU takes the received radio block into account only when it contains a data portion intended for that WTRU (conditions B or D).

In a second embodiment, the WTRU takes the received radio blocks into account when either the data portion, the PAN field, or both are addressed to it. This means that conditions B, C, or D will trigger the WTRU to process the radio block in terms of measurements.

One skilled in the art would be able to build and apply more rules to the measurement process from conditions A-D. For example, the conditions to be taken into account may be configured by the network through signaling or may be given by a rule set implemented in the WTRU.

It is noted that the different embodiments listed above may also be used to trigger more than one measurement process on the received radio blocks as a function of conditions A-D. For example, a first measurement process resulting in a first measurement quality may be started when the WTRU receives a data portion in a radio block (irrespective if the PAN is addressed to it). Therefore, when conditions B or D exist, a first measurement quality is extracted and/or updated. A second measurement process resulting in a second measurement quality is started only when condition C is met, e.g., a PAN field intended for that WTRU is contained in the radio block.

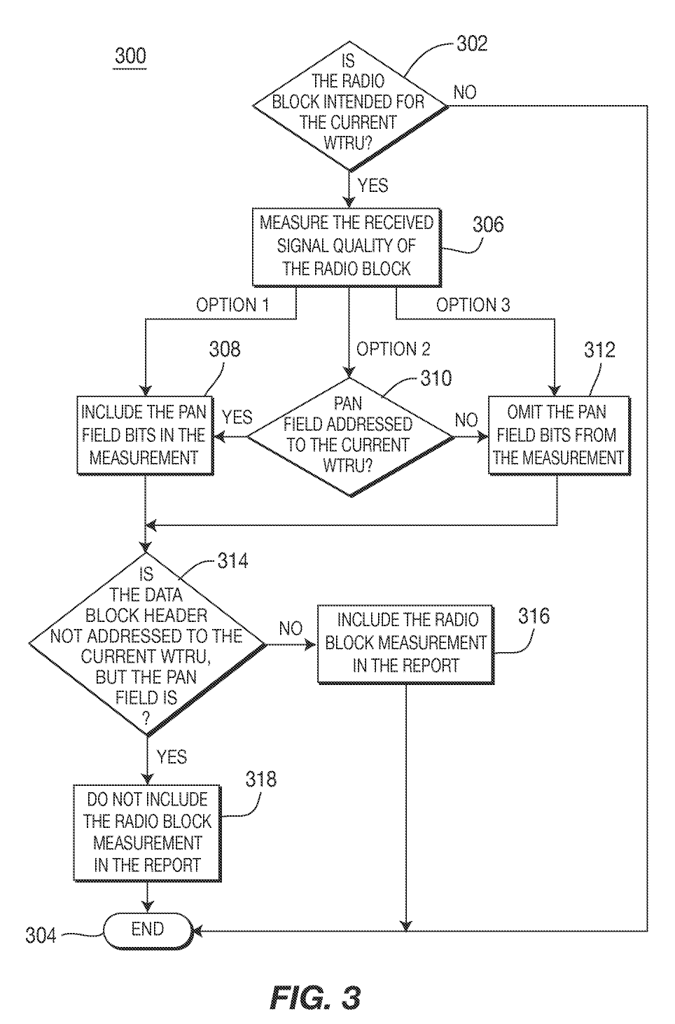

FIG. 3 is a flowchart of a method 300 for supporting the PAN field in taking measurements during an EGRPS DL TBF transfer illustrating the case for decoding against occurrence of conditions B and D described above. The method 300 begins by determining whether the received radio block is intended for the current WTRU (step 302). A radio block is intended for the current WTRU where (1) the TFI identifying the current WRTU can be decoded from the RLC/MAC header or (2) the TFI identifying the current WTRU can be decoded from the RLC/MAC control block header. If the data portion of the received radio block is not intended for the current WTRU, e.g., either conditions A or C apply, then the method terminates (step 304).

If the data portion of the radio block is intended for the current WTRU (step 302), e.g., either of the remaining conditions B or D applies, then the received signal quality of the radio block is measured (step 306). Subsequently, a metric representative of the received radio block is determined, updated, and reported according to any of the embodiments described below.

It is noted that the method shown in FIG. 3 applies equally to other cases, like when an additional step is introduced to determine if the PAN portion of the radio block is intended for that WTRU, e.g., distinguish between conditions B and D. Similarly, the measurement process can be based on a determination if either conditions B, C, or D are met; e.g., as long as any portion of the received radio block is intended for that WTRU, a metric representative of the received radio block is determined.

In a second method in regard to assessing and reporting on the quality of the PAN messages, three options are proposed to determine whether the PAN bits are included in the measurements when the WTRU determines if a received radio block needs to be taken into account for determining a metric (e.g., signal quality) from that radio block.

In a first option, the raw bits assigned to the PAN field are always included in the measurements (step 308). The first option is preferred when it is reliable to assume that the PAN field has been correctly decoded, based on the observation that the PAN field is generally more reliable than the basic transmission blocks.

In a second option, a determination is made whether the PAN field is addressed to the current WTRU (step 310). If the PAN field is addressed to the current WTRU, then the PAN field bits are included in the measurements (step 308). If the PAN field is not addressed to the current WTRU (step 310), the PAN field bits are omitted from the measurements (step 312). The second option is preferred if it is unreliable to assume that the PAN field has been correctly decoded, given that it is not addressed to the receiving WTRU.

In a third option, the PAN field bits are always omitted from the measurements (step 312). The third option is preferred if either the added complexity of determining whether or not the PAN field is correctly received is unjustified, or if the PAN field raw bits are not of the same quality as the raw bits supporting the main body of the burst.

After the measurement is taken, a determination is made whether the data portion for the received radio block is addressed to the current WTRU and whether the PAN field is addressed to the current WTRU (step 314). If the data portion of the radio block is addressed to the current WTRU, then the measurements for this radio block are included in the measurement report (step 316) and the method terminates (step 304). If the data portion is not addressed to the current WTRU but the PAN field is addressed to the current WTRU (step 314), then the measurements for this radio block are not included in the measurement report (step 318) and the method terminates (step 304).

In an alternative method, the following options in regard to assessing and reporting on the quality of PAN messages are proposed. If a PAN field is received and is addressed to a WTRU's TFI, the WTRU measures the received signal quality of the PAN field and stores it as part of a new category called the PAN field measurement quality. For this function, two options may be considered:

(1) The WTRU only measures the PAN signal quality when the PAN is addressed to a TFI different than the data portion of the received radio block.

(2) The WTRU measures the PAN signal quality independent of whether the PAN is addressed to the same TFI as the data portion of the received radio block.

There are Three Options for Reporting the Pan Field Quality:

(1) The rules for averaging are modified to be optimized for the expected frequency of occurrence of the PANs. For example, smaller values can be used for the forgetting factors in the averaging process.

(2) New averaging rules are created, specifically tailored for the PAN parameters. For example, only the last decoded PAN field is decoded, or an average of the last N received PAN fields is reported.

(3) There is no averaging and the quality for each received PAN is computed and all relevant parameters are stored. Messages are created to send the PAN quality reports, on an individual basis, to the network. This may be the only viable approach if the frequency of PAN transmissions to a WTRU is small, making averaging impractical.

Two options for the RLC/MAC protocol may be used to facilitate the processes above.

(1) The existing signaling messages, e.g., Packet DL Assignment, Packet UL Assignment, Multiple TBF Assignment, Packet Measurement Order, Packet TS Reconfigure, Multiple TS Reconfigure, Packet CS Release, Packet Cell Change Notification, and Packet Cell Change Order can be reused to convey the necessary measurement parameters to the WTRU.

(2) Create new messages, to be used in case of latency reduction, from the network to the WTRU.

For the actual reporting mechanism, the WTRU may either operate corresponding to the legacy behavior, i.e., using UL messages such as Packet Measurement Report or EGPRS Packet DL ACK/NACK, or new messages may be introduced.

The PAN messages may be infrequent and may be piggy-backed onto messages for any of several WTRUs, not necessarily the one reporting the quality. Because of this, a special message is needed to provide a non-averaged set of values for a single transmission and to provide sufficient information to allow the base station to match the report to the intended primary WTRU (i.e., the WTRU receiving the primary message).

Modifications to Support the RTTI

If the transmissions are sent at the RTTI, Table 2 can be modified to include new parameters appropriate for the case where there are more samples within the BEP_PERIOD. The BEP_PERIOD2 is sent to individual WTRUs on the PACCH DL. The BEP_PERIOD is broadcast on the PBCCH or, if the PBCCH does not exist, then it is broadcast on the BCCH.

TABLE 2

| | Field value | | | | | | | | | | | | | | | |
|---|---|---|---|---|---|---|---|---|---|---|---|---|---|---|---|---|
| | 15 | 14 | 13 | 12 | 11 | 10 | 9 | 8 | 7 | 6 | 5 | 4 | 3 | 2 | 1 | 0 |
| BEP_PERIOD | Reserved | | | | | 25 | 20 | 15 | 12 | 10 | 7 | 5 | 4 | 3 | 2 | 1 |
| e₁ | — | | | | | 0.08 | 0.1 | 0.15 | 0.2 | 0.25 | 0.3 | 0.4 | 0.5 | 0.65 | 0.8 | 1 |
| BEP_PERIOD2 | Norm | 90 | 70 | 55 | 40 | 25 | 20 | 15 | 12 | 10 | 7 | 5 | 4 | 3 | 2 | 1 |
| e₂ | e₁ | 0.03 | 0.04 | 0.05 | 0.065 | 0.08 | 0.1 | 0.15 | 0.2 | 0.25 | 0.3 | 0.4 | 0.5 | 0.65 | 0.8 | 1 |

Modified Forgetting Factor Approach

In a modified forgetting factor approach, a number of alternatives may be used to provide values for the forgetting factor, e.

(1) No new signaling is used, but the WTRU uses e₁ and obtains the e₁ value corresponding to the cell's broadcast value of BEP_PERIOD. The e₁ value is divided by a factor F, where F is determined by detailed optimization. The factor F can be stored in the network and the WTRU as part of a rule. Alternatively, the factor F can be signaled to the WTRU. In one embodiment, the value of F is less than 2. Referring to Table 2, the values of e₁ are nominally 2/BEP_PERIOD, except for very small values of BEP_PERIOD. Therefore, if the WTRU is in RTTI mode, the effective BEP_PERIOD is increased by F and the e value is replaced by e divided by F. For a Field Value=0, e₁ remains at 1. As an alternate embodiment, the averaging of the R factor is modified such that

Rₙ=(1−e)·Rₙ₋₁+βe·xₙ, R₋₁=0 Equation (8)

is replaced by

Rₙ=(1−e)·Rₙ₋₁+e/F·xₙ, R₋₁=0. Equation (9)

The modified equation requires a new interpretation of Rₙ. If all data blocks are correctly decoded, then Rₙ converges to F. This results in optimal filtering for the quality averages.

In one alternative embodiment, a functional equivalent to above modification using the factor F is used to introduce the following updated procedure when computing the R quality factors for the RTTI case. In an RTTI configuration, when a WTRU decodes a radio block intended for it, the quality parameters individually averaged per timeslot pair. The averaging case can also be dependent on the modulation type employed on a particular received transmission.

A first parameter x_{n,a} is a binary flag indicating the existence of quality parameters for the first 10 ms RTTI radio block. A second parameter x_{n,b} is a corresponding flag indicating the existence of quality parameters for the second 10 ms RTTI radio block.

$${R}_{n} = ( 1 - e ) \cdot {R}_{n - 1} + e \cdot \frac{{x}_{n , a} + {x}_{n , b}}{2} , {R}_{- 1} = 0. \qquad Equation ( 10 )$$

Therefore, when the WTRU receives RTTI transmissions, the averaged Rₙ quality value is determined as by averaging across the RTTI intervals and is converted into an equivalent BTTI value. The modification factor F constitutes an averaging constant applied to the individual RTTI measurements executed on the different transmission time period(s) where the WTRU received one or more radio block(s).

(2) No new signaling is used, but the WTRU uses e₁ and computes an equivalent BEP_PERIOD. This may be to multiply the value of BEP_PERIOD by F. For example, referring to Table 2, if the Field value=4, for BTTI the BEP_PERIOD=5×F and the value, modified for RTTI, becomes BEP_PERIOD=5F. If this value is in the table, then the WTRU uses that value from the table for BEP_PERIOD. If this value is not in the table, then the WTRU must use interpolation. For cases where the modified BEP_PERIOD will be greater than or equal to 30, rules must be established to define values for e₁. One example rule is to use values for e₂.

(3) For cells assigning BEP_PERIOD2 a value not equal to 15, the cell selects a BEP_PERIOD which is determined to be optimal, considering all factors, including the transmission rates associated with the RTTI. The exact procedure for computing the optimal value for a given WTRU is a design decision for the base station/network.

(4) Similar to alternative (3), except that all cells supporting RTTI employ BEP_PERIOD2, where the BEP_PERIOD2 is not equal to 15.

(5) As shown in Table 3, defining the values for e₁ and e₂ for field values 0 to 15, may be modified to define a set of values for e₃, which replace e₁ for any specified field value of the BEP_PERIOD. A first set and a second set of e values may be communicated to the WTRUs, or given by a rule and employed as a function of RTTI versus BTTI transmissions received by the WTRUs. For illustrative purposes, Table 3 assumes that F equals 2. The values shown are only for illustration and other values may be used after simulation. It is assumed that the values would change; since these tables have included e₃ values consistent with option (1), option (5) may be used to eliminate executable statements.

TABLE 3

| | Field value | | | | | | | | | | | | | | | |
|---|---|---|---|---|---|---|---|---|---|---|---|---|---|---|---|---|
| | 15 | 14 | 13 | 12 | 11 | 10 | 9 | 8 | 7 | 6 | 5 | 4 | 3 | 2 | 1 | 0 |
| BEP_PERIOD | Reserved | | | | | 25 | 20 | 15 | 12 | 10 | 7 | 5 | 4 | 3 | 2 | 1 |
| e₁ | — | | | | | 0.08 | 0.1 | 0.15 | 0.2 | 0.25 | 0.3 | 0.4 | 0.5 | 0.65 | 0.8 | 1 |
| BEP_PERIOD2 | Norm | 90 | 70 | 55 | 40 | 25 | 20 | 15 | 12 | 10 | 7 | 5 | 4 | 3 | 2 | 1 |
| e₂ | e₁ | 0.03 | 0.04 | 0.05 | 0.065 | 0.08 | 0.1 | 0.15 | 0.2 | 0.25 | 0.3 | 0.4 | 0.5 | 0.65 | 0.8 | 1 |
| BEP_PERIOD3 | | | | | | 50 | 40 | 30 | 24 | 20 | 14 | 10 | 8 | 6 | 4 | 2 |
| e₃ | | .015 | .02 | .025 | .033 | .04 | .05 | 08 | .1 | .13 | .15 | .2 | .25 | .33 | .04 | 1 |

Multislot Equivalence Approach

A multislot equivalence approach may be used. This approach treats the RTTI measurements as BTTI multislot measurements by combining two RTTI radio blocks.

FIG. 4 shows radio block transmissions in BTTI and RTTI modes. A radio block includes four radio bursts. B1 and B2 are two radio blocks, including four radio bursts each, namely {B11, B12, B13, B14} and {B21, B22, B23, B24} respectively. In the traditional BTTI mode, a TTI includes four frames (labeled as 1-2-3-4 horizontally in the top part of FIG. 4). In RTTI mode, a TTI includes two frames, as shown in the bottom part of FIG. 4. Each frame includes eight timeslots, labeled from 0-7 vertically (e.g., only timeslots 0 and 1 are depicted in FIG. 4). In the top part of FIG. 4, one Packet Data Channel (PDCH) is defined in terms of timeslot 0, for all frames (within the duration of a TBF), which is represented as PDCH-0. Also shown in the bottom part of FIG. 4 is a second PDCH, defined in terms of timeslot 0 and timeslot 1 for all frames, which is represented as PDCH-01.

In BTTI mode, one radio block (B1) is transmitted on PDCH-0 within frames 1-4. In RTTI mode, two radio blocks (B1 and B2) are transmitted on PDCH-01 within frames 1-4. After the two RTTI radio blocks B1 and B2 are correctly decoded, {B11, B12, B21, B22} and {B13, B14, B23, B24} are treated as two pseudo-BTTI radio blocks. The MEAN_BEP and CV_BEP values are measured/filtered according to the rules defined for BTTI multislot configuration.

This approach uses an even number of RTTI radio blocks. When an odd number of RTTI radio blocks is received during one reporting period, one RTTI radio block needs special treatment. The one RTTI radio block may be discarded or the per-block per-slot MEAN_BEP and CV_BEP are estimated based on two bursts transmitted on the same channel during one RTTI. Any technique known to one skilled in the art can be used to execute the MEAN BEP and/or CV_BEP measurements on an individual burst. For example, this measurement can be taken by observing mean and/or variance values over the expected symbol constellations of the data portion or the training sequence portion of a burst.

In this approach, the forgetting factors do not need to be re-optimized for the RTTI case.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for accounting for the presence of a piggybacked acknowledgement/negative acknowledgement (PAN) field in reporting a received signal quality for a current wireless transmit/receive unit (WTRU), comprising:
determining whether a received radio block is intended for the current WTRU;
measuring the received signal quality of the radio block if the radio block is intended for the current WTRU;
including bits from the PAN field in determining the received signal quality of the radio block based on a preconfigured option; and
including the radio block measurement in a measurement report if a data header of the radio block is not addressed to the current WTRU but the PAN field is addressed to the current WTRU.

2. The method according to claim 1, wherein determining whether the received radio block is intended for the current WTRU includes examining a radio link control/medium access control header of the radio block to determine if it contains a data portion addressed to the current WTRU.

3. The method according to claim 2, wherein the data portion of the radio block is addressed to the current WTRU if a temporary flow identity in the header identifies the current WTRU.

4. The method according to claim 1, wherein determining whether the received radio block is intended for the current WTRU includes examining a radio link control/medium access control header of the radio block to determine if it contains a PAN field.

5. The method according to claim 4, wherein the presence of a PAN field in the radio block is indicated by a code point setting.

6. The method according to claim 4, wherein the presence of a PAN field in the radio block is indicated by a PAN indicator.

7. The method according to claim 1, wherein the bits from the PAN field are included in determining the received signal quality of the radio block.

8. The method according to claim 1, wherein the bits from the PAN field are included in determining the received signal quality of the radio block if the PAN field is addressed to the current WTRU.

9. The method according to claim 1, wherein the bits from the PAN field are omitted from determining the received signal quality of the radio block.

10. The method according to claim 1, wherein the bits from the PAN field are omitted from determining the received signal quality of the radio block if the PAN field is not addressed to the current WTRU.

11. A wireless transmit/receive unit (WTRU), comprising:
an antenna;
a receiver in communication with the antenna;
a transmitter in communication with the antenna; and
a processor in communication with the receiver and the transmitter, the processor configured to:
determine whether a received radio block is intended for the WTRU;
measure a received signal quality of the radio block if the radio block is intended for the WTRU;
include bits from a piggybacked acknowledgement/negative acknowledgement (PAN) field in determining the received signal quality of the radio block based on a preconfigured option; and
include the radio block measurement in a measurement report if a data header of the radio block is not addressed to the WTRU but the PAN field is addressed to the WTRU.

12. The WTRU according to claim 11, wherein the processor is further configured to examine a radio link control/medium access control header of the radio block to determine if it contains a data portion addressed to the WTRU to determine whether the received radio block is intended for the WTRU.

13. The WTRU according to claim 11, wherein the processor is further configured to examine a radio link control/medium access control header of the radio block to determine if it contains a PAN field to determine whether the received radio block is intended for the WTRU.

14. The WTRU according to claim 11, wherein the processor is further configured to include the bits from the PAN field in determining the received signal quality of the radio block.

15. The WTRU according to claim 11, wherein the processor is further configured to include the bits from the PAN field in determining the received signal quality of the radio block if the PAN field is addressed to the WTRU.

16. The WTRU according to claim 11, wherein the processor is further configured to omit the bits from the PAN field from determining the received signal quality of the radio block.

17. The WTRU according to claim 11, wherein the processor is further configured to omit the bits from the PAN field from determining the received signal quality of the radio block if the PAN field is not addressed to the WTRU.

18. A method for determining a reliability of a filtered quality parameter of a received radio block, comprising:
receiving a quality parameter;
determining the reliability of the quality parameter by the equation:
Rₙ=(1−e)·Rₙ₋₁+e/F·xₙ, R₋₁=0,
where Rₙ is the reliability of the filtered quality parameters, e is a forgetting factor, F is an optimization factor, and xₙ indicates whether quality parameters for the n^{th} radio block exist.

19. The method according to claim 18, wherein if all data blocks are correctly decoded, Rₙ converges to F.

20. The method according to claim 18, wherein
the value of e is related to a bit error probability over a defined time interval (BEP_PERIOD); and
the value of BEP_PERIOD is multiplied by F to obtain a new value for e.
